(19) United States
(12) Patent Application Publication
(10) Pub. No.: US 2003/0066803 A1
(43) Pub. Date: Apr. 10, 2003

(54) Analytical instrument calibration and data correction

(76) Inventor: Adrian Geoffrey Wright, Sandwich (GB)

Correspondence Address: PFIZER INC., PATENT DEPARTMENT, MS8260-1611, EASTERN POINT ROAD, GROTON, CT, 06340, US

(21) Appl. No.: 10/263,999

(22) Filed: Oct. 2, 2002

Related U.S. Application Data
(60) Provisional application No. 60/336,188, filed on Oct. 30, 2001.

(30) Foreign Application Priority Data
Oct. 5, 2001 (GB) 0124024.1

(51) Int. Cl. B01D 15/08

(52) U.S. Cl. 210/656; 210/198.2

(57) ABSTRACT

A method and data processing apparatus are provided for correcting liquid chromatography data from an evaporative light scattering detector. The method includes the steps of determining the concentration of a solvent for the time at which a substance was detected by the detector. The detector response is determined as a function of mass for that solvent concentration from solvent calibration data and mass calibration data. The actual mass of the substance can then be determined by comparing the measured response of the detector for the substance to the detector response.

The present invention relates to the calibration of an analytical instrument, and in particular to the calibration of an evaporative light scattering detector (ELSD) and the correction of measured data to improve the accuracy of chromatography data.

An evaporative light scattering detector (ELSD) can be used with a chromatography device, such as a high performance liquid chromatography (hplc) device. The chromatography device and detector provide a chromatography instrument which can be used as an analytical instrument to determine the amounts of the different, individual component substances present in a mixture of substances. As is well understood by persons of skill in this art, a chromatography device separates the component substances and a detector is used to measure the amount of each separated component substance.

In general, it is important that a chromatography instrument can accurately measure the relative amounts of the different components of a mixture and also accurately determine the absolute amount of each component. A particular application of such an instrument in the field of pharmaceuticals is to determine the purity of a chemical compound. In this case it is especially important to be able to measure small amounts of impurities owing to the potential toxic effect of such impurities on a subject. The present invention therefore addresses the need to provide an analytical instrument having an improved accuracy. The present invention also addresses the problem of providing a universal analytical instrument which can provide accurate quantitative measurements independently of the nature of the substances being detected.

A previous method has been used to try and improve the performance of an ELSD to provide usefully accurate quantitative measures of the amounts of different substances present in a mixture of substances. However, it only provides usefully accurate quantitative measurements in the case that the amounts of the different components present do not differ from each other by more than 50%. The previous method assumes that the detector response (R) follows a simple power law with respect to the concentration of compounds in solvent (R═RₒC^{m}), and obtains the power, m, from a plot of the logarithm of R against the logarithm of C. This log-log function is assumed to be linear. The effect of solvent concentration on the detector response is then taken into account by assuming that the detector response Rₒ depends linearly on the time at which a measurement is taken. Therefore the method approximates the detector response, over its full range of operation, with two assumptions of a linear detector response function.

However, the method only provides accurate quantitative measurements over a very limited range of compositions of the components of the mixture. Outside of those ranges, the method can be inaccurate by orders of magnitude, which can be important in determining the level of impurity components present. The present invention addresses this problem by using a calibration data set encompassing the whole useful range of composition proportions and solvent concentrations and using an analysis method that does not assume linear detector response functions over the entire range of operation of the detector nor significantly approximates the detector response.

According to a first aspect of the present invention, there is provided a method for correcting liquid chromatography data from an evaporative light scattering detector, comprising the steps of determining a solvent concentration for the time at which a substance was detected by the detector, determining a detector response characteristic as a function of mass for the solvent concentration from solvent calibration data and mass calibration data and comparing the measured response of the detector for the substance to the detector response characteristic to determine the actual mass of the substance.

A calibrated detector response is represented by calibration data which indicates how the response of the detector varies with the concentration of solvent and the mass of substance present obtained from actual measurements at or around those concentration and mass values. The solvent concentration at the time a substance was detected by the detector is used to determine a response function, or characteristic, of the detector from the solvent calibration data, for different masses, using the mass calibration data. The actual mass of substance is then calculated from the measured detector response, using the detector response characteristic for the solvent concentration. The detector response characteristic or function, can be a smooth continuous function, but does not need to be as calibration data is available over the range of typical operating parameters of the chromatography device. The method can be computer implemented.

The mass calibration data and/or the solvent calibration data can be derived from measured detector calibration data. The mass and/or solvent calibration data can be data which has been calculated from measured detector calibration data, or can be measured detector calibration data. The measured calibration data can extend over the whole working range of the detector: i.e. from the lowest to the highest masses of substances and concentrations of solvent as used in the hplc art. The measured calibration data or data set preferably corresponds to substantially all possible permutations of mass and concentration parameters at which hplc measurements would be made. In this way, the accuracy of the correction method can be ensured for any measurements taken using the hplc device, as all corrections are based on real measurements rather than approximations.

Preferably, the range of measured calibration data allows impurity levels below approximately 10% of the major component in a mixture to be accurately determined.

The measured detector calibration data can be collected for a plurality of different substances. This provides a universal detector correction procedure as any variations in calibration data for different substances is averaged out. Preferably the substances are all pharmaceutical like substances.

The detector response characteristic for the solvent concentration can be determined by an interpolation of solvent calibration data. Interpolation allows a more accurate detector response characteristic to be determined for the solvent concentration of interest if there is no solvent calibration data that exactly matches. If the variation in detector response with solvent concentration is small around the solvent concentration of interest, then the solvent calibration data itself can be used as a reasonable approximation. The interpolation can be linear, which provides a reasonable balance between computational overheads and accuracy. The interpolation can use a higher order function, such as quadratic, quartic, etc.

The step of comparing the measured detector response with the detector response characteristic can include an interpolation of the detector response characteristic in order to calculate the actual mass of substance. A linear interpolation can be used, or a higher order function can be used.

According to another aspect of the present invention there is provided an electronic data processing apparatus for correcting high-performance liquid chromatography data from an evaporative light scattering detector, comprising a storage device storing mass calibration data and solvent calibration data and a data processor in communication with the storage device, in which data representing the detected amount of light scattered from a substance by the evaporative light scattering detector and data representing the solvent concentration at the time the substance was detected is processed by the data processor by using the solvent concentration data to determine a detector response characteristic as a function of mass for that solvent concentration from the solvent calibration data and the mass calibration data and comparing the measured response of the detector for the substance to the detector response characteristic to determine the actual mass of the substance.

According to a further aspect of the present invention there is provided computer program code executable by an electronic data processing apparatus to carry out a method according to a first aspect of the invention, or to provide data processing apparatus according to a another aspect of the invention.

According to a further aspect of the present invention, there is provided an analytical instrument comprising a liquid chromatography device, an evaporative light scattering detector and an electronic data processing apparatus, according to a previous aspect of the invention. This provides an analytical instrument having increased accuracy in determining the composition of mixtures of substances, particularly for small masses of the component substances of a mixture. Such a device is particularly suitable for use in assessing the purity of pharmaceutical products.

According to a yet further aspect of the present invention, there is provided a data structure for use in correcting chromatography device data from an evaporative light scattering detector, the data structure comprising data representing the response of the evaporative light scattering detector as a function of a known mass of substance and a known solvent concentration. Such a data structure can be used by a data processing apparatus to provide a calibration surface which can be used to correct measured data to allow a more accurate value for the mass of a substance to be determined.

According to a further aspect of the present invention, there is provided a method of generating calibration data for evaporative light scattering data from an evaporative light scattering detector of a liquid chromatography device without a hplc column, comprising the steps of measuring the evaporative light scattering detector response for different known masses of substance and for different known solvent concentrations. Preferably, different known masses of different substances are used. This provides a more universal calibration data set as substance specific features in the calibration data are averaged out. Preferably the substances are pharmaceuticals like substances.

An embodiment of the invention will now be described in detail, and by way of example only, and with reference to the accompanying drawings, in which:

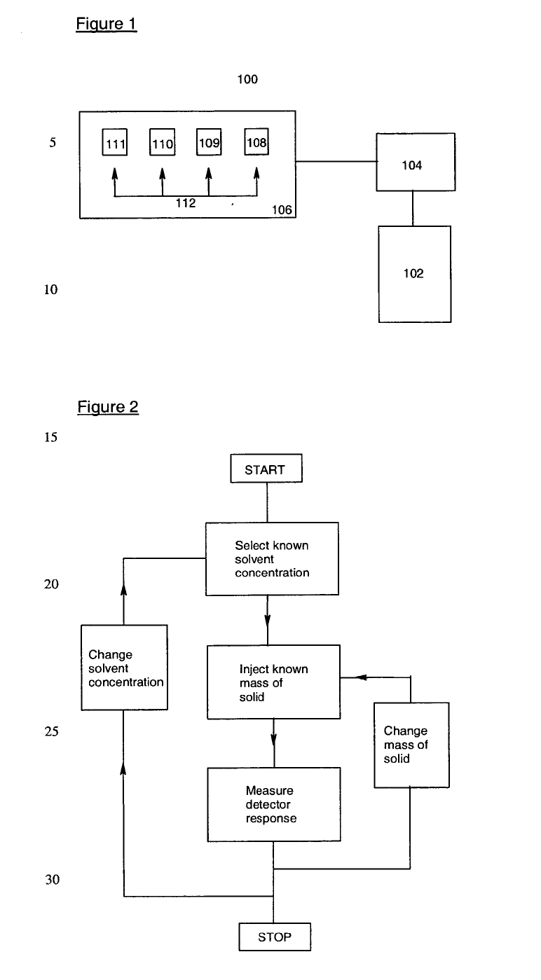

FIG. 1 shows a schematic block diagram of a chromatography instrument suitable for calibration according to an aspect of the invention;

FIG. 2 shows a flow chart illustrating a method of calibrating an ELSD of the instrument shown in FIG. 1;

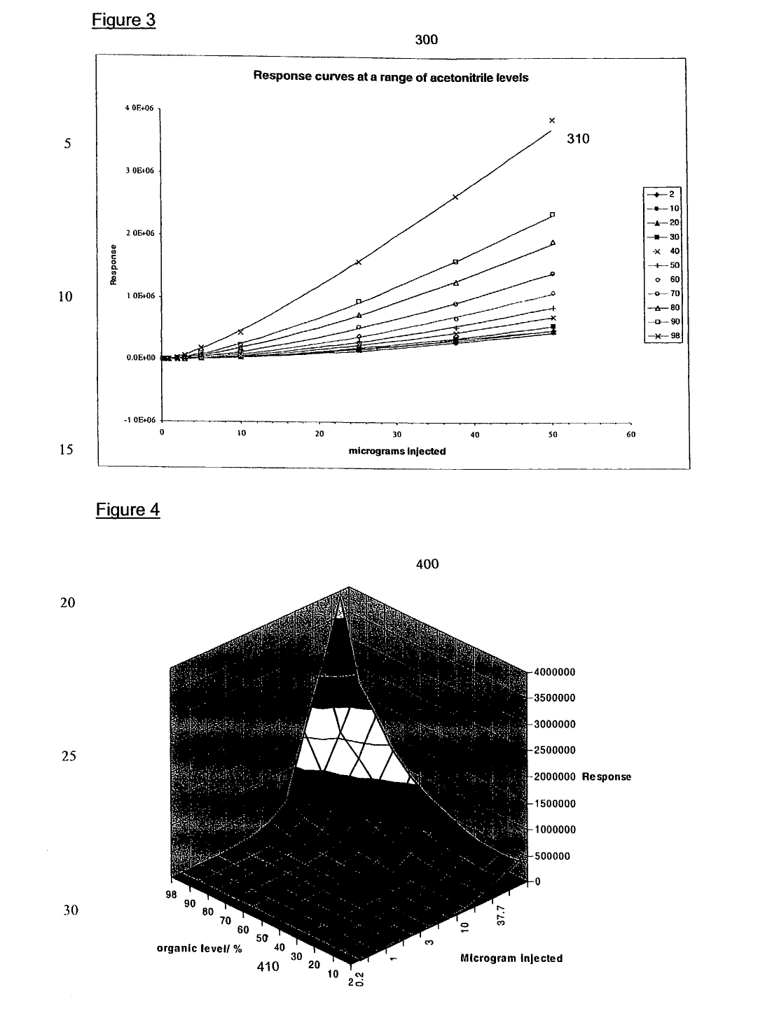

FIG. 3 shows a graph illustrating ELSD calibration data curves;

FIG. 4 shows a graph illustrating a ‘surface’ plot of ELSD calibration data;

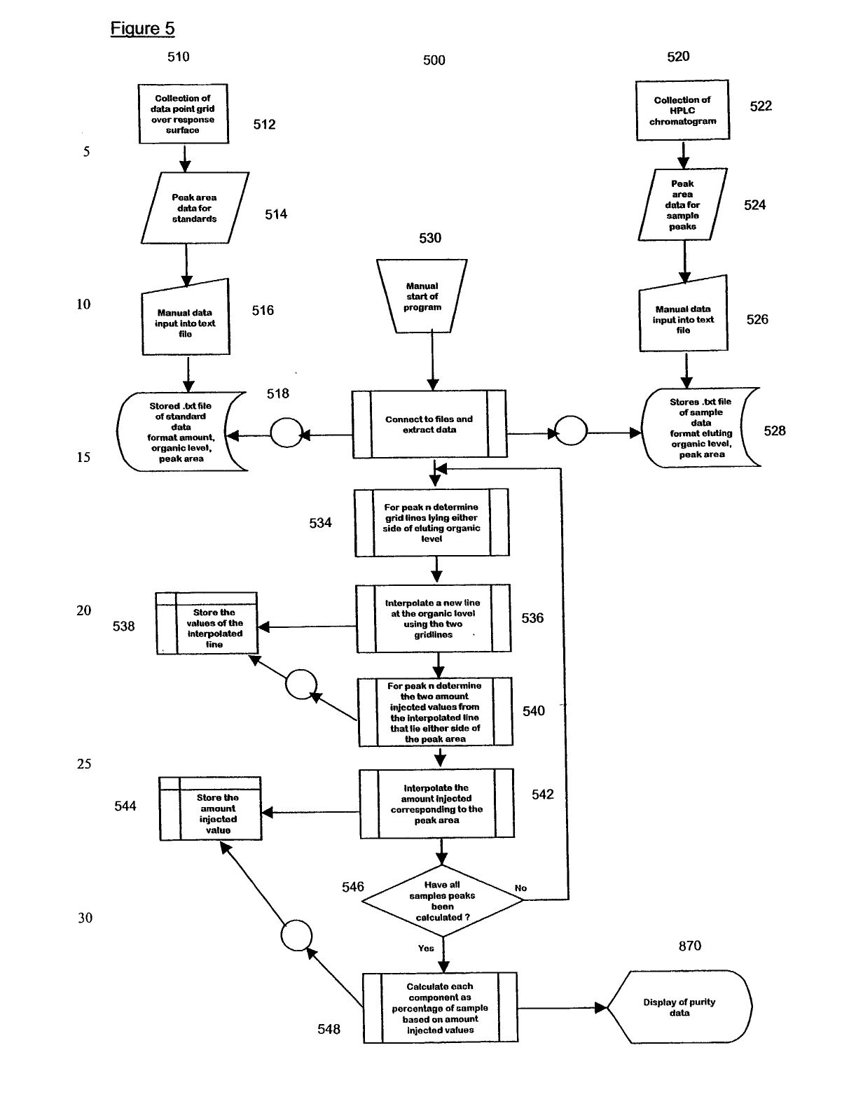

FIG. 5 shows a flow chart illustrating the functionality of a computer program implementing a data correction method according to an aspect of the invention;

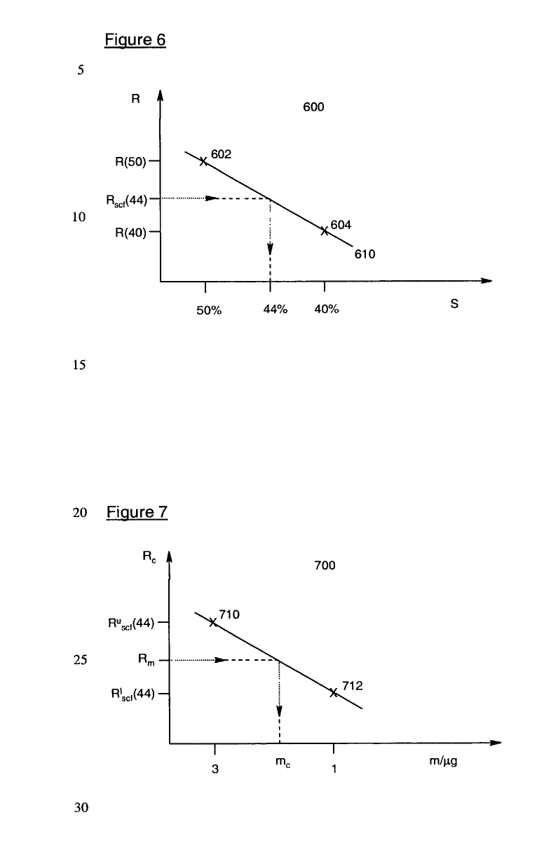

FIGS. 6 and 7 respectively show graphs illustrating interpolation steps of the data correction method; and

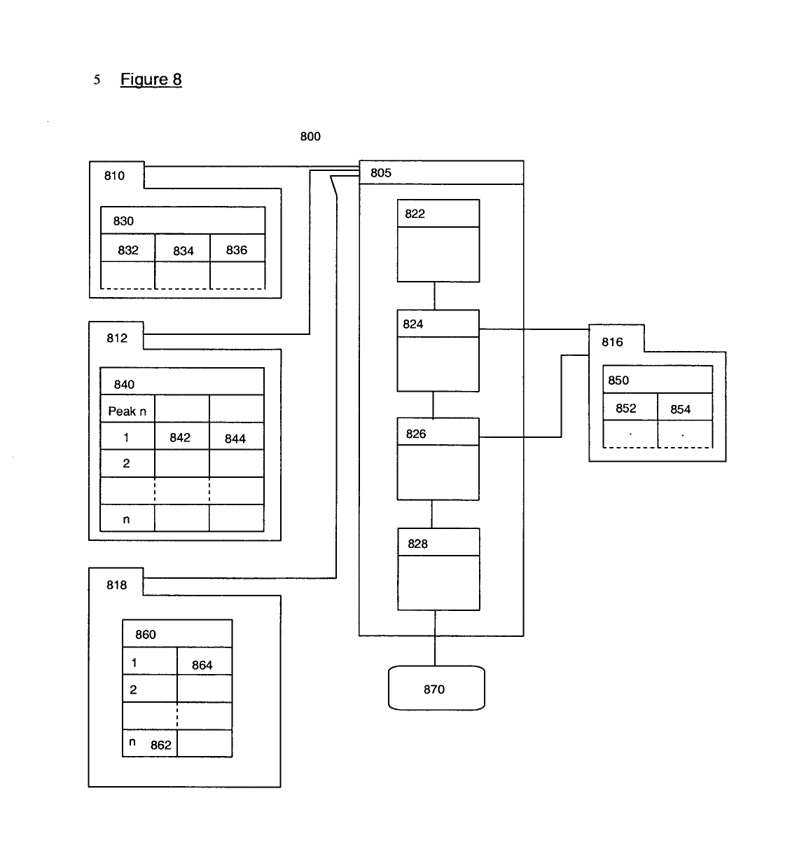

FIG. 8 shows a schematic diagram illustrating the architecture of an ELSD data correction program according to an aspect of the invention.

Similar items in different figures have common reference numerals unless indicated otherwise.

With reference to FIG. 1, there is shown an analytical instrument, designated generally by reference numeral 100, comprising a liquid chromatography device 102, an evaporative light scattering detector 104 and a computer 106 which provides an electronic data processing apparatus. The liquid chromatography device 102, which is suitable for high performance liquid chromatography (hplc), and the detector 104 are both of conventional design. The computer, shown schematically in FIG. 1, is also of conventional design and includes a microprocessor 108, random access memory (RAM) 109, read only memory (ROM) 110, and a mass storage device 111 (such as a hard disk, optical disk or CD-Rom drive) in communication via a bus 112. The computer provides data processing functions to process electronic data signals supplied to the computer by the detector 104 and to process data collected from the detector, under control of software. FIG. 1 is schematic and by way of illustration only and other parts of the computer 106 are provided as necessary and as will be understood by a person of ordinary skill in this area of technology.

The detector 104 includes detector electronics which provide an electrical data output signal, indicative of the detected scattered light intensity, which is supplied as an electrical data input signal to an input/output interface (not shown) of the computer 106. The output electrical data signal from the detector is an analogue signal proportional to the instantaneous scattered light intensity as a function of time. This signal has a peak corresponding to each component compound detected by the detector, and each peak is integrated by conventional chromatographic data handling software running on the computer to provide an indication of the area under each peak.

The liquid chromatography device 102 can be used to separate a mixture of substances dissolved in a solvent, also referred to as a solvent stream. The substances can be in solid or liquid form, such as an oil. The solvent, or eluent, comprises an aqueous component and an organic component. The proportion of organic component in the solvent defines the concentration of the solvent.

Detector 104 is connected at the bottom of the chromatography column. The detector includes a nebulizer which generates a fine spray of the solvent including the separated components of the mixture of substances. The nebulising gas flow and pressure in the detector causes the spray, or mist, of separated substance to travel along an evaporation chamber surrounded by an evaporator heater which evaporates the solvent. A conventional diffuser component can be provided in the evaporation chamber, but is not necessary. A plume of dried particles of the separated substance then passes through a detection chamber before leaving the detector via an exhaust.

The detection chamber includes a light source generating a beam of white light which is directed substantially perpendicularly to the substantially linear travel path of the particles of separated substance through the detection chamber. A light detector is provided at an angle of substantially 120? to the incident light beam and in a plane substantially perpendicular to the particle path. The light detector detects the intensity of light scattered from the particles of substance passing through the incident light beam.

As an alternative to white light, a source of coloured light can be provided and the light source can be a laser.

Conventional electronic circuitry is provided for the detector which converts the intensity of detected light into a corresponding electrical signal, and the analogue electrical data signal is output from the detector and supplied to the computer for processing by the chromatography data processing software as described above. The output of the light detector is a series of peaks as a function of time, each peak corresponding to the separate components of the initial mixture of substances, and with the area under each peak representing the mass of each component present in the original mixture. The software detects peaks in the signal and integrates the peaks in the data signal. The area under each peak is representative of the mass of each substance having passed through the incident light beam.

The following procedure is used to generate calibration data for the detector so as to allow an accurate quantitative indication of the mass of substances present to be determined from the raw data. The intensity of scattered light is substantially determined by the bulk properties of a substance and therefore is substantially independent of the chemical composition of the substance passing through the incident light beam.

Calibration of the detector is carried out by determining the detector response as a function of both mass of solid and solvent composition. FIG. 2 shows a flow chart 200 illustrating a method for generating detector calibration data according to an aspect of the invention. It will be appreciated that the order in which mass and solvent calibration data is collected (different masses as a function of different solvent concentrations or vice versa) is not important.

The calibration of the detector is carried out by operating the hplc system in its normal manner, except that the hplc column is removed and replaced by a stainless steel union to which the ELSD is connected. The calibration samples are simply injected into a flowing solvent stream and the system is operated in a loop injection mode, akin to flow injection analysis. The solvent stream composition ranges from approximately 2% organic through to approximately 98% organic in order to define a full range of calibration data. The flow rate of the solvent stream is approximately 1 ml/min. The organic component of the solvent stream is acetonitrile. The other component is water.

A first known concentration (2% acetonitrile volume/volume with the aqueous) of solvent is selected for the solvent stream. A first known mass of a test, or calibration, solid is dissolved in a dissolution solvent (for example, acetonitrile:water 50:50 v/v mixture). The test solid used is a typical pharmaceutical like compound, such as a solid, non-hygroscopic compound that complies with Lipinski's rule of 5. A small amount, for example a few microlitres, of the solution of the first known mass of test solid is injected into the solvent stream having the first known concentration of solvent. When injected into the flowing solvent, some mixing occurs. The small amount of dissolution solvent is diluted by the solvent stream to such an extent that the overall solvent composition essentially matches that of the solvent stream alone, when the test solid enters the detector. The integrated peak data value is determined by the computer and stored.

A second known mass of solid is then dissolved in the dissolution solvent and injected into the same known concentration of solvent in the solvent stream and passed through the chromatography device and again the peak area detector determined and stored. This is repeated for a series of different known masses of solid covering a range of values from close to 0 μg up to, for example, approximately 50 μg of solid at 10 μg steps.

This process is then repeated for series of solvent streams each having a known, different organic concentration and over a range of solvent stream concentration values from approximately 0 to approximately 100%: for example 2%, 10%, 20%, 30%, 40%, 50%, 60%, 70%, 80%, 90%, 98%. It is important to use a range of solvent calibration data which encompasses the whole typical working range of the hplc device and detector to ensure that the actual variations in the performance of the detector at any typical hplc working parameter is covered.

FIG. 3 shows a graph 300 illustrating the measured detector response (peak area) as a function of μg of solid material, with each calibration curve 310 corresponding to a different solvent concentration, as determined using this method. In FIG. 3, the abscissa is linear and represents mass of standard compound in units of micrograms. The ordinate is linear and represents the area under a detected peak as an arbitrary absolute value.

FIG. 4 shows a three dimensional (3-D) surface plot 400 illustrating the same data as that plotted in FIG. 3, with detector response plotted as a linear function of solvent concentration and a logarithmic function of solid mass. (The logarithmic solid mass axis is used merely to allow the data to be more easily visualised and has no bearing on the correction method.) As can be seen, the detector response is a non-linear function of both the solvent composition and mass of substance. Therefore, in order to obtain an accurate quantitative determination of the mass of a substance, it is necessary to correct the raw peak area data using such a calibration surface.

FIG. 5 shows a flow diagram 500 illustrating how the calibration data is used in a data correction procedure to enable an accurate determination of an unknown mass of the component substances of a sample. The calibration data collection and formatting procedure 510 includes the principal steps of collecting the calibration data for the calibration surface 512, as described above and illustrated in FIG. 2. The computer 106 then has a data set 514 of peak areas as functions of solvent concentration and sample mass. This calibration data data set is then manually 516, or automatically, re-formatted and stored in a file 518 for use by a data correction data program.

Limb 520 of FIG. 5 illustrates the collection of raw hplc data for correction. The sample, comprising the unknown mixture of substances, is dissolved and injected in a solvent stream having a known concentration. In practice a suitable chromatographic solvent used for the separation is a compositional variant of acetonitrile and an aqueous component. The dissolution solvent used to dissolve the sample to be analysed is not important as it does not significantly influence the measurement process. The dissolution solvent merely has to be able to dissolve the sample so that it can be injected into the solvent stream. The chromatographic separation is carried out 522 and the output data from the detector is captured and processed by the computer 106 and the uncorrected peak area data is stored in an uncorrected detector data file 524.

The chromatographic separation 522 is carried out by a gradient run in which the solvent composition changes in a programmed way. The organic component increases linearly over a specified time. The system dwell time and the column dead time are taken into account so that the solvent composition of the solvent for each separated component as it is detected in the detector chamber can be calculated. It is necessary to accurately know the solvent composition at the time that each separated component is present in the detector chamber, detected by the ELSD and the peak data for that component captured. The captured detector peak area data is then manually, or automatically if the solvent concentration data is also recorded by computer 106, re-formatted 526 together with the associated solvent concentration for the time corresponding to the time at which the peak data was detected, and stored in a data file 528. The peak area/solvent concentration data file 528 can be formatted as a simple array including a peak identifier, a peak area data items and a corresponding solvent concentration data item, for each of the detected peaks.

The captured detector data is then corrected by a computer program using the previously determined calibration data according to the following procedure illustrated by the body 530 of flow diagram 500. For a peak, the solvent concentration for that peak is obtained from the stored solvent concentration data file 528. If the solvent concentration corresponds to a one of the measured solvent calibration curves then that calibration curve can be used. If the solvent concentration falls between a pair of solvent calibration curves 534, then an approximate solvent calibration curve for the actual solvent concentration is determined 536. The approximate solvent calibration curve 410 is generated by an interpolation between the measured detector response at the two known solvent concentration levels. The approximate solvent calibration curve so generated corresponds to the solvent concentration at which the detector response was actually measured. The approximate solvent calibration curve data is stored 538.

In more detail, and with reference to FIG. 6, there is shown a graph 600 by way of illustrating of the interpolation step 536. Graph 600 shows a plot of the detector response calibration data R as a function of the solvent concentration calibration data S for a one of the known masses. If the scattered light peak of interest was measured for a solvent concentration of 44%, then it is necessary to generate an approximate solvent calibration curve 410 corresponding to the 44% solvent concentration. During the calibration procedure, the detector response at the 50% (R(50)) 602 and 40% (R(40)) 604 concentration levels were measured. The detector response solvent calibration factor at 44% (R_{scf}(44)) is calculated from a linear regression through the data points R(50) 602 and R(40) 604.

The line 610 is of the general form R=aS+b, where a and b are constants, and from which, S being known as 44%, R_{scf}(44) can be calculated for the particular known mass. This procedure is repeated for all of the known masses until a calculated detector response data set comprising the calculated values of R_{scf}(44) as a function of mass, corresponding to points on the approximate calibration curve 410 for the 44% solvent concentration level of interest, has been generated. This data set is stored in step 538.

A linear regression provides satisfactory results, although a higher order polynomial expression can be used (eg quadratic, quartic, etc) when the increase in accuracy would merit it.

Next the corrected actual mass of substance is determined 540 by using the measured detector response Rₘ for the peak and an interpolation between the corrected detector responses R_{scf}(⁴⁴) to calculate a corrected value for the actual mass of substance m_{c}. If the measure detector response corresponding to the peak of interest Rₘ=50,000 then the set of corrected detector responses is searched to determine the pair of corrected detector response values immediately greater (R^{u}_{scf}(44)) and less (R^{l}_{scf}(44)) than this value, eg 71,000 and 34,000, each of which corresponds to a known mass.

FIG. 7 shows a graph 700 of a plot of the corrected detector response R_{c} as a function of mass m in μg. The corrected mass m_{c} is determined by an interpolation 542 between the corrected detector responses for the known mass values. In a similar way to that described above, a linear regression through the data points 710, 712 corresponding to R^{u}(44) and R^{l}(44) is used to calculate the corrected mass of the component corresponding to the peak of interest. The corrected mass m_{c} is a better measure of the actual mass of substance as the detector response has been corrected for the effects of both solvent concentration and mass. The corrected mass data item is then stored 544.

The correction procedure is applied to the data for each peak 546 corresponding to each of the component substances of the initial mixture of substance fed through the chromatography device, thereby providing a corrected measure of the mass of each component. The total mass is calculated by summing the masses of the separated components. The proportion of each component is then given by the mass of the component divided by the total mass 548.

Without the correction procedure described above, an ELSD detector tends to indicate, for low masses, that there is less of that component present in the mixture than is actually the case. This is particularly important in assessing the purity of pharmaceuticals.

Table 1 shows the results of using the correction procedure for four mixtures of four compounds A, B, C and D having different proportions of the four component compounds. The four compounds A, B, C and D are pharmaceutical compounds that obey the Lipinski rule of 5 but that have different structures. These test samples were all dissolved in acetonitrile:DMSO, 10:90% by volume, which is a useful dissolution solvent, but not essential. As can be seen, the purity of the mixture of substances as determined from the corrected detector measurements, compared to the uncorrected detector measurements, is closer to the known actual purity. Correction for the detector effects on small masses, which correspond to low concentrations, of a substance are particularly important. The presence of low concentrations of an impurity can be underestimated by factors of hundreds of percent, whereas the corrected proportions can be accurate to within tens of a percent.

TABLE 1

| | Uncorrected ELSD | | Corrected ELSD |
|---|---|---|---|
| Substance | measured purity % | Actual purity % | measured purity % |
| A | 93.3 | 81.6 | 83.3 |
| B | 4.2 | 10.0 | 9.8 |
| C | 1.1 | 4.3 | 3.6 |
| D | 1.3 | 4.1 | 3.1 |
| A | 93.8 | 82.2 | 84.6 |
| B | 1.4 | 5.1 | 5.2 |
| C | 1.1 | 4.3 | 3.7 |
| D | 3.7 | 8.3 | 6.0 |
| A | 0.7 | 4.2 | 5.3 |
| B | 1.1 | 5.1 | 6.3 |
| C | 97.1 | 86.7 | 84.3 |
| D | 1.0 | 4.2 | 3.9 |
| A | 0.7 | 3.8 | 4.4 |
| B | 98.7 | 93.0 | 92.4 |
| C | 0.3 | 1.7 | 1.8 |
| D | 0.3 | 1.5 | 1.3 |
| A | 0.4 | 4.3 | 5.1 |
| B | 0.7 | 5.3 | 6.9 |
| C | 0.5 | 4.5 | 4.6 |
| D | 98.4 | 85.9 | 83.1 |

The architecture of a computer program implementing the data correction method will now be briefly discussed, with reference to FIGS. 5 and 8. The specific details of an implementation of a suitable computer program are, unless indicated otherwise, considered to be within the ability of a computer programmer of ordinary skill in light of the foregoing and following discussion and so have not been described in greater detail.

The data correction program architecture 800 includes a main program body 805 having access to a number of files having data structures storing, and for storing, data items representing various items of information. Data items are read from and written to these files by the program which processes the data items. Data is also transferred to and from RAM by the program as required during processing of the data. The data files used by the program include a calibration data file 810, a measured data file 812, a calculated data file 816 and a results file 818, corresponding to 518, 528, 538 and 544 respectively.

The calibration data file 810 includes a calibration data data structure 830 which includes fields for holding data items representing a peak area 832, a mass 834 and a solvent concentration 836 for each calibration point of the 3-D calibration surface.

The measured data file 812 includes a measured data data structure 840 which includes fields for holding data items representing a measured peak area 842 and solvent concentration 844 for each peak n of the N peaks measured. The peak area data items and solvent concentration data items are associated by the time of detection of component corresponding to the peak data.

The calculated data file 816 includes a calculated data data structure 850 which includes fields at least for holding calculated data items representing the calculated detector response 852, from processing part 824, and mass 854 derived from the calibration data file 810. The calculated data data structure 850 can also include fields for storing data generated and used during the interpolation steps.

The results file 818 includes a results data data structure 860 which includes fields for holding a data item 862 representing the peak number and the corrected mass 864.

The program principally comprises four processing routines. Although shown separately for the sake of clarity some of the functionality of one routine may be provided by another routine. A first part 822 handles the extraction of relevant data from the calibration data file 810 and from the measured data file 812, which is passed down the processing chain as required by the other parts of the program.

A second part 824 handles derivation of approximate concentration calibration curve data by carrying out a linear regression of the detector response and concentration calibration data from the calibration file 810, and stores the approximate concentration calibration curve data in calculated data file 816.

A third part 826, includes routines to identify from the calculated calibration curve data, the calculated detector responses bounding the measured detector response data item for the peak of interest, and from a linear regression of the upper and lower calculated responses, determines the corrected mass, which is stored in the results file 818.

Looping control 546 is provided to ensure that the correction procedure carried out by the second and third parts is carried out for all the peaks represented in the measured data file 812.

A fourth part 828, includes routines to produce results data, including a routine 548 to calculate the proportion of component from a summation of the individual component masses.

The program finally generates an output 870 including an indication of the corrected mass of each component and the proportion of each component.

The data correction procedure described above provides an analytical instrument capable of producing highly accurate compositional measurements on many pharmaceutical like compounds and therefore provides a universal detector.

1. A method for correcting liquid chromatography data from an evaporative light scattering detector, comprising the steps of:
determining a solvent concentration for the time at which a substance was detected by the detector;
determining a detector response characteristic as a function of mass for the solvent concentration from solvent calibration data and mass calibration data; and
comparing the measured response of the detector for the substance to the detector response characteristic to determine the actual mass of the substance.

2. A method as claimed in claim 1, in which the mass calibration data and/or the solvent calibration data are derived from measured detector calibration data.

3. A method as claimed in claim 2, in which the measured detector calibration data has been collected for a plurality of different substances.

4. A method as claimed in claim 2, in which the detector response characteristic for the solvent concentration is determined by an interpolation of solvent calibration data.

5. A method as claimed in claim 2, in which the step of comparing the measured detector response with the detector response characteristic includes an interpolation of the detector response characteristic in order to calculate the actual mass of substance.

6. A method as claimed in claim 4 or 5, in which the interpolation is linear.

7. An electronic data processing apparatus for correcting liquid chromatography data from an evaporative light scattering detector, comprising:
a storage device storing mass calibration data and solvent calibration data; and
a data processor in communication with the storage device, in which data representing the detected amount of light scattered from a substance by the evaporative light scattering detector and data representing the solvent concentration at the time the substance was detected is processed by the data processor by using the solvent concentration data to determine a detector response characteristic as a function of mass for that solvent concentration from the solvent calibration data and the mass calibration data; and
comparing the measured response of the detector for the substance to the detector response characteristic to determine the actual mass of the substance.

8. Computer program code executable by an electronic data processing apparatus to carry out the method of claim 1.

9. Computer program code executable by an electronic data processing apparatus to provide the apparatus of claim 7.

10. An analytical instrument comprising a liquid chromatography device, an evaporative light scattering detector and an electronic data processing apparatus, as claimed in claim 7.

11. A data structure for use in correcting chromatography device data from an evaporative light scattering detector, the data structure comprising data representing the response of the evaporative light scattering detector as a function of a known mass of substance and a known solvent concentration.

12. A method of generating calibration data for evaporative light scattering data from an evaporative light scattering detector of a liquid chromatography device without a hplc column, comprising the steps of measuring the evaporative light scattering detector response for different known masses of substance and for different known solvent concentrations.
